(19) United States
(12) Patent Application Publication
(10) Pub. No.: US 2007/0285407 A1
(43) Pub. Date: Dec. 13, 2007

(54) Enhanced user interface for an oscilloscope

(76) Inventors: Evan A. Dickinson, Portland, OR (US); Gary J. Waldo, Hillsboro, OR (US)

Correspondence Address: THOMAS F. LENIHAN;TEKTRONIX, INC., 14150 S. W. KARL BRAUN DRIVE, P.O. BOX 500 (50-LAW), BEAVERTON, OR, 97077-0001, US

(21) Appl. No.: 11/436,862

(22) Filed: May 17, 2006

(51) Int. Cl. G09G 5/00; G06F 3/038

(52) U.S. Cl. 345/204

(57) ABSTRACT

A user interface for an oscilloscope, or the like, simultaneously displays data in a plurality of selectable formats, such as hexadecimal or binary, and allows a user to edit the data in a selected one of the formats. The data is input by an operator of the oscilloscope and used to trigger the oscilloscope or is used as a search term for searching a received oscilloscope data record for an occurrence of that data. The content of the operator-entered data may be text or numeric data or it may be representative of a memory address. The individual digits of the data or whole blocks of data may be selected for entry or editing.

### BACKGROUND OF THE INVENTION

Oscilloscopes are becoming very powerful with added processing functions. Newer oscilloscopes may allow a user to trigger the device when a certain address is accessed, or when a particular data value is written to memory. Graphical interfaces of the oscilloscopes may be becoming more sophisticated. Users may require data to be changed and entered via a user interface. Some user interfaces may require a user to input values in a particular format, such as binary. Therefore, the user may have to convert data to the format accepted by the oscilloscope. This may require time and add to user frustration by forcing the user to convert everything to the only format accepted by the oscilloscope, and convert data from the oscilloscope to a format desired by the user.

### SUMMARY OF THE INVENTION

A user interface for an oscilloscope, or the like, displays data in a plurality of selectable formats, such as hexadecimal or binary, simultaneously. The user interface also allows a user to edit the data in a selected one of the formats. The data is input by an operator of the oscilloscope and used for triggering the oscilloscope or as a search term for searching a received data record in an oscilloscope for an occurrence of that data. The content of the operator-entered data may be text or numeric data or it may be representative of a memory address, for example an address of an I²C bus, or an identifier of a CAN bus. Individual digits or larger blocks of data may be selected for entering or editing.

### BRIEF DESCRIPTION OF THE DRAWING

Claimed subject matter is particularly pointed out and distinctly claimed in the concluding portion of the specification. However, both as to organization and/or method of operation, together with objects, features, and/or advantages thereof, may best be understood by reference to the following detailed description when read with the accompanying drawings in which:

FIG. 1 is a block diagram of an oscilloscope having enhanced interface capabilities in accordance with one or more embodiments;

FIG. 2 is a diagram of a user interface of an oscilloscope in accordance with one or more embodiments;

FIG. 3 is a diagram of a user interface of an oscilloscope in accordance with one or more embodiments;

FIG. 4 is a diagram of a user interface of an oscilloscope in accordance with one or more embodiments;

FIG. 5 is a diagram of a user interface of an oscilloscope in accordance with one or more embodiments;

FIG. 6 is a flow diagram of a method for enhanced user interface for an oscilloscope in accordance with one or more embodiments;

### DETAILED DESCRIPTION OF THE EMBODIMENTS

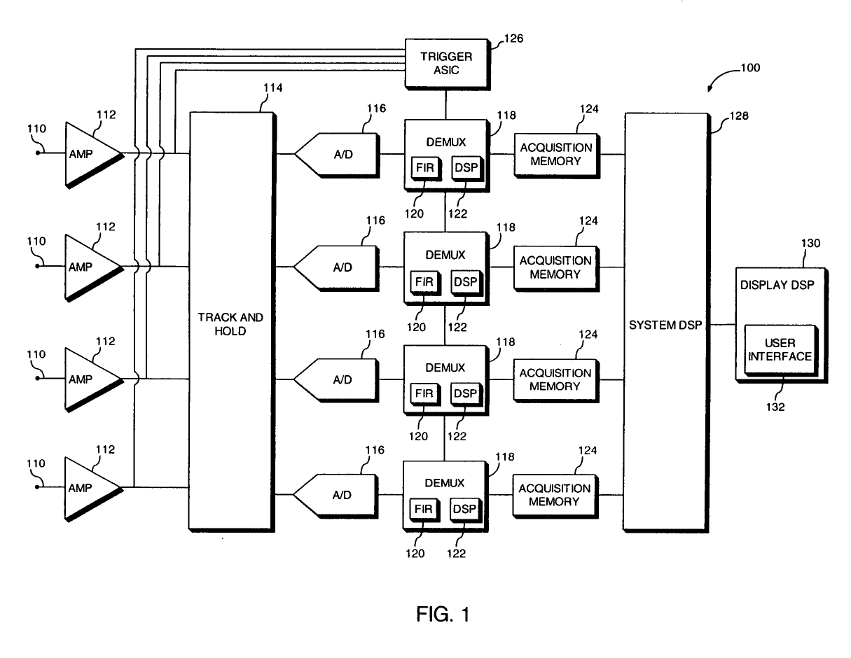

Referring to FIG. 1, oscilloscope 100 may have one or more channels 110 that may include an analog amplifier 112 and optionally an attenuator (not shown) to receive one or more input signals to be analyzed by oscilloscope 100.

A signal applied to an input of channel 110 is coupled to a track and hold circuit 114, which may be embodied as an integrated circuit (IC). Track and hold circuit 114 receives the analog output signal from amplifier 112 on one or more of channels 110 of oscilloscope 100. Track and hold circuit 114 operates as an analog switch to route the signals to one or more analog-to-digital (A/D) converters 116 disposed in channels 110. Oscilloscope 100 may provide four channel operation wherein an amplifier 112 is connected to a corresponding A/D converter 116 for that corresponding channel 110.

Continuing with this particular example, the output signals of A/D converters 116 feed into a respective demultiplexer (DEMUX) 118, which may, for example, be embodied in an integrated circuit as illustrated. DEMUX 118 may perform one or several different functions, and, in one embodiment, DEMUX 118 may receive samples of a signal on a channel 110 from an A/D converter 116 at the rate of the A/D converter write the samples to an acquisition memory 124 at a rate matching and/or slower than a rate of A/D converter 116. For example, DEMUX 118 may write 16 or 32 samples at a time to acquisition memory 124. Furthermore, DEMUX 118 may also include various digital signal processors (DSP) implemented in hardware, and DEMUX may include a dedicated DSP circuit 122 and a FIR filter 120.

Acquisition memory 124 may be a different block than the main memory (not shown) for system DSP (Digital Signal Processor) 128. DEMUX 118 has a circular addressing and control logic and receives triggers from a trigger system 126. In one embodiment, trigger system 126 may be realized as an applications specific integrated circuit (ASIC). The data stream of signal samples is continuously written in a circular fashion wherein past data is overwritten until a trigger event occurs. After a desired amount of post trigger data is captured by DEMUX 118 and written to acquisition memory 124, DEMUX 118 ceases to write to acquisition memory 124. Once the data is acquired by acquisition memory, system DSP 128 may then perform one or more digital signal processing operations on the data. Furthermore, data may be passed back from system DSP 128 through DEMUX 118 to perform additional DSP operations.

System DSP 128 receives signal-related data from acquisition memory 124, processes that data, and ultimately displays a waveform representative of that data on a display of a display controller (Display DSP) 130. An enhanced user interface 132 is associated with Display DSP 130 and is used by an operator to enter or edit data used as search criteria or as data to trigger oscilloscope 100. Oscilloscope 100 may be configured to trigger from many different types of events. The triggering events may include a particular register being written to, or a particular value being written to memory, among many other triggers. That is, the content of the operator-entered data may be text or numeric data or it may be representative of a memory address, for example an address of an 12C bus, or an identifier of a CAN bus.

Heretofore, test and measurement instruments, such as oscilloscopes, have had controls and displays that restricted the form of the data that could be entered by a user to a single format, for example binary format.

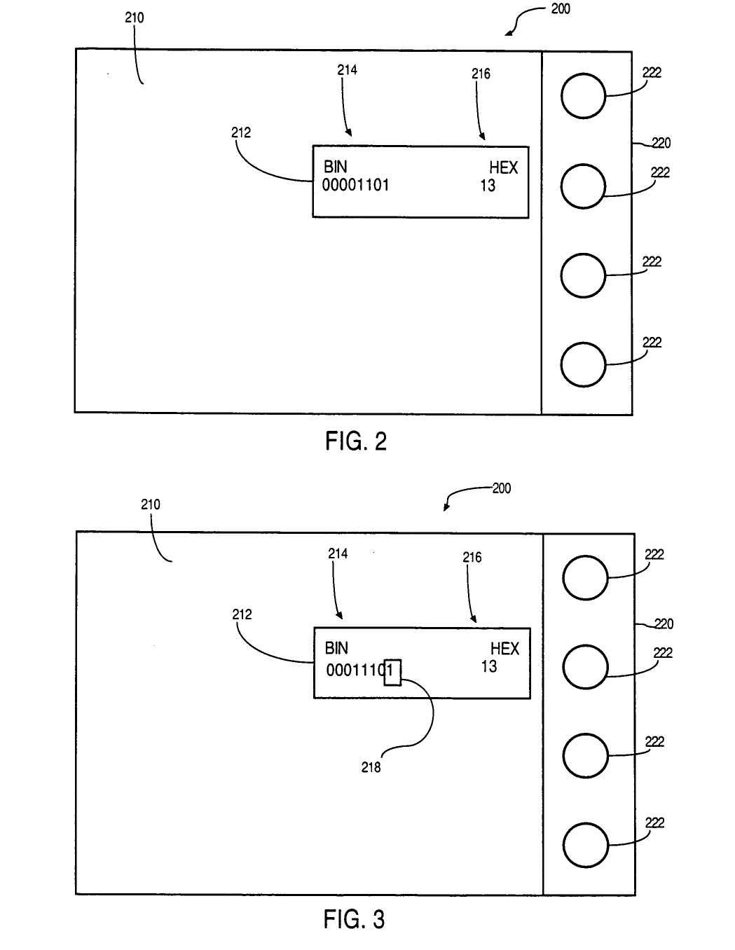

Referring now to FIG. 2, a user interface 200 of an oscilloscope is shown in which user interface 200 may be a graphical user interface (GUI) and includes a display portion 210 and an input portion 220. Display portion 210 may be configured to receive data and to display the data graphically, numerically, or in many other ways. Specifically, the data to be entered by a user may be a search term used by the oscilloscope to search through an acquisition record looking for an occurrence of that search term. The data may be text or numeric data, or it may be representative of a memory address. Input portion 220 allows a user to manipulate the data displayed by display portion 210. In various embodiments, input portion 220 may include one or more input devices 222, such as, but not limited to, buttons, pushbuttons, knobs, actuators, selectors, or combinations thereof, among many other types of input devices.

In one such embodiment, display portion 210 includes a data display portion 212. Data display portion 212 may be configured to display addresses and/or values of specific memory addresses, among other data to be displayed. It is important to note that data display 212 portion displays the same data simultaneously in several different formats 214, 216. That is, data is displayed in both hexadecimal and binary format. Such a display in multiple formats allows a user to view addresses and data in different formats at the same time, and allows easy and simultaneous selection of both the format and digits of the data for editing purposes.

Referring now to FIG. 3, a graphical user interface (GUI) 200 of an oscilloscope is shown in which GUI 200 again includes a display portion 210 and an input portion 220. Display portion 210 includes a data display portion 212, which includes an indicator 218. Indicator 218 indicates data that is selected in a first format (binary) 214. The data is selected or edited utilizing input devices 222. The individual bits or digits of data may be selected for editing, as shown. This allows a user to edit the displayed data very precisely for relatively small changes. Furthermore, entire registers, or blocks of data may also be edited. The GUI of the subject invention allows a user to enter any binary digit (i.e., as an “H”, or an “L”) corresponding to a binary 1 or 0, or to enter an X to represent a “don't care” condition at that particular location in the binary number.

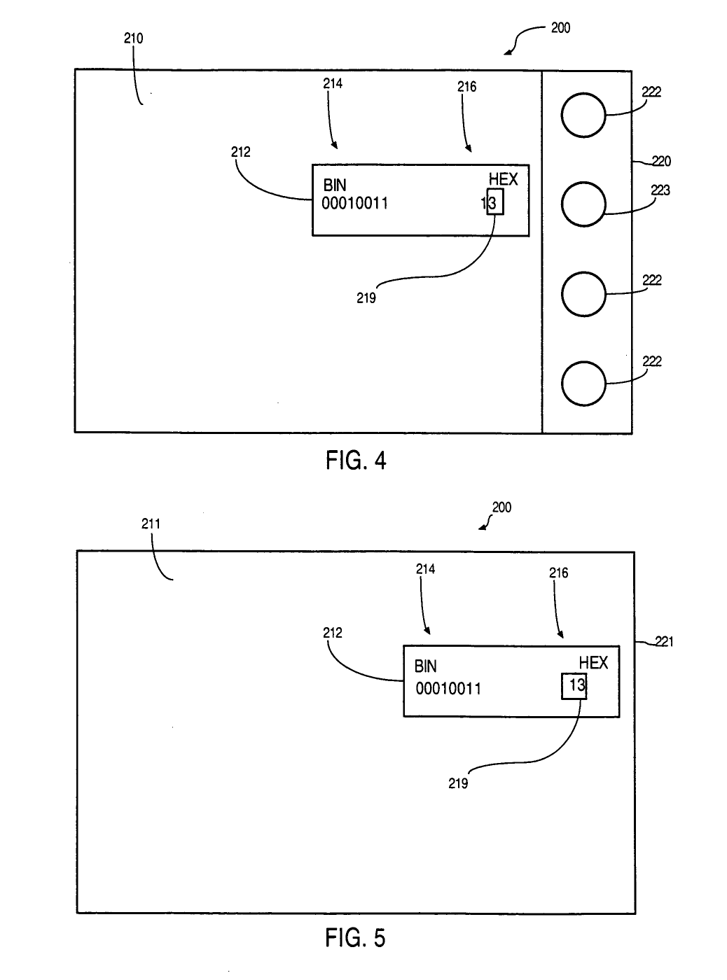

Referring now to FIG. 4, a graphical user interface (GUI) 200 of an oscilloscope again includes a display portion 210, an input portion 220, and an indicator 219. Indicator 219 indicates data that is selected in a second format (hexadecimal) 216. The data is selected or edited utilizing one or more input devices 222. Individual bits and/or digits of data may be selected for editing, as shown.

Heretofore, a user may have needed to change a search term from, for example, “0011₂” to “1111₂”. While it would have been desirable to display that data in more easily read hexadecimal format “3₁₆” and change it directly to “F₁₆”, such operation was not possible because the interface being employed in the oscilloscope did not display or allow editing in anything other than binary format. An example of such an interface is the SPI interface in the MSO6104A oscilloscope manufactured by Agilent Corp. It is noted that the I²C interface of that same oscilloscope requires data input in hexadecimal, and does not display in binary. There are times when one would like to work in binary, and other times when working in hexadecimal is preferable. Requiring a user to engage in a separate operation to perform a format conversion between the two, so that he can enter the data in the only format allowed, is both time consuming, and prone to error. The GUI of the subject invention displays the data in multiple formats. As shown in FIG. 4, the user is allowed to select hexadecimal format and can thereafter enter any hexadecimal digit (i.e., from 0₁₆ to F₁₆), or to enter an X for a “don't care” condition at any particular location in the hexadecimal expression.

That is, the subject system allows individual bits, groups of bits, blocks of data, entire registers, or other size blocks of data to be selected for editing in either displayed format. An operator uses an input device 222 to simultaneously select the both the data format and the data block to be edited 219. This may be accomplished by turning a first multipurpose knob 223 to select the data to be edited 219. The first multipurpose knob 223, or a different knob 222, may be turned to change or edit the currently selected data 219. The manner of display and selection of the data allows a user to easily edit different portions of the data in a convenient format, without the need for a separate conversion procedure, thereby saving the user time. Both edited and non-edited data can be saved by pressing the first multipurpose knob 223, or employing another user input 222 from the user interface 220.

Referring now to FIG. 5, a graphical user interface (GUI) 201 includes a display portion 211 and an input portion 221, such as a touch screen, touch pad, or a touch panel. In this embodiment, display portion 211 also includes an indicator 219 indicating a block of data that has been selected in a second format 216. It is important to note that selection of a block of data, rather than selection of just a single bit or digit at a time, allows easy changing of data from, for example OF₁₆ to 10₁₆. In FIG. 5, it can be seen that a user has already selected a block of data by use of touch screen 221. Although indicator 219 is shown as a box around the selected data, other indicators may be utilized, such as but not limited to, highlighting, graying, or many other indicators, as desired.

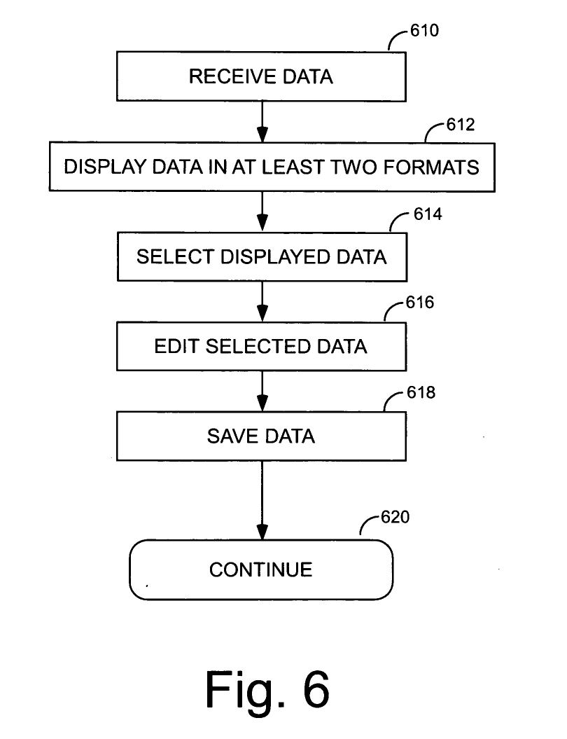

Referring now to FIG. 6, a flow diagram of a method to display and edit data for an oscilloscope in accordance with one or more embodiments will be discussed. As shown in FIG. 6, method 600 may include receiving data at block 610. Data may be received at a GUI 200, 201 wherein the data is entered by a user. GUI 200, 201 may then display the data in a selected one of a plurality of formats 612 on a display portion 210, 211 of GUI 200, 201.

Displayed data may then be selected for editing 614 via input portion 220, 221. A user utilizes input device 222 to simultaneously select both the data format and the data block to be edited. This may be accomplished by turning a first multipurpose knob to select the data to be edited. The selected data may then be edited at step 616 by turning the first, or a different knob. The edited and non-edited data is saved at step 618. The saving may be accomplished by pressing the first, or another knob from the user interface. The process then continues at 620 by entering new data, or by editing a different search term. When process shown in the flowchart of FIG. 6 is complete, the oscilloscope may be controlled to search for the entered or edited search terms in the acquisition data, and trigger the oscilloscope upon detecting its occurrence.

Although the invention was described in terms of displaying, and allowing editing, in two formats (binary and hexadecimal), one skilled in the art will understand that the data may be displayed, and editing allowed, in more than two formats. Such other formats may be for example, binary coded decimal, ascii text, octal digits, etc.

The use of the word “or” in the following claims is intended to be in the inclusive (i.e., Boolean) sense, meaning one, or the other, or both. Moreover, the use of the word “or” does not imply that both alternatives must be present; it is sufficient if either alternative is present alone, but both alternatives may be present, as well.

What is claimed is:

1. A user interface for an oscilloscope, comprising:
a display portion of the oscilloscope, said display portion displaying data in a plurality of formats substantially simultaneously; and
a user input portion of the oscilloscope comprising an input device, said input device being user-operable for entering said data and operable for selecting said data in one of said plurality of formats for editing said selected data.

2. The user interface for an oscilloscope as claimed in claim 1, wherein said plurality of formats includes at least a hexadecimal format, and a binary format.

3. The user interface for an oscilloscope as claimed in claim 1 wherein selection of said data for editing and selection of said one of said plurality of formats are both accomplished with said input device at the same time.

4. The user interface for an oscilloscope as claimed in claim 3 wherein said selection of said data accomplished with said input device comprises selection of individual digits or selection of blocks of said data.

5. The user interface for an oscilloscope as claimed in claim 1, wherein said data is a data value.

6. The user interface for an oscilloscope as claimed in claim 1, wherein said data is representative of an address of a memory location.

7. The user interface for an oscilloscope as claimed in claim 1, wherein said data is representative of an identifier of a CAN bus.

8. The user interface for an oscilloscope as claimed in claim 1, wherein said data is a search term to be used by said oscilloscope to search acquisition data for an occurrence of said search term.

9. The user interface for an oscilloscope as claimed in claim 1, wherein said input device is one of a selector, button, pushbutton, actuator, knob, touch panel, or combinations thereof.

10. The user interface for an oscilloscope as claimed in claim 1, wherein the input device is multipurpose.

11. The user interface for an oscilloscope as claimed in claim 1, wherein the oscilloscope is capable of triggering upon detection of said search term in said acquisition data.

12. A method of controlling the display and editing of an oscilloscope, comprising:
receiving user-entered data;
displaying said received data in a plurality of formats on a display screen of an oscilloscope;
selecting data in a first format from said plurality of formats; and
editing said data in said first format.

13. The method of claim 12, wherein
said plurality of formats comprises at least hexadecimal format and binary format.

14. The method of claim 12, further comprising:
selecting data in a second format from said plurality of formats.

15. The method of claim 12, further comprising:
editing said data in said second format.
